(19) United States
(12) Patent Application Publication
(10) Pub. No.: US 2021/0405777 A1
(43) Pub. Date: Dec. 30, 2021

(54) TRANSACTION CARD MICRO STYLUS

(71) Applicants: LOUIS LAZO, DENVER, CO (US); NATE STURGES, DENVER, CO (US)

(72) Inventors: LOUIS LAZO, DENVER, CO (US); NATE STURGES, DENVER, CO (US)

(21) Appl. No.: 17/358,571

(22) Filed: Jun. 25, 2021

Related U.S. Application Data
(60) Provisional application No. 63/044,543, filed on Jun. 26, 2020.

(51) Int. Cl. G06F 3/0354

(52) U.S. Cl. CPC G06F 3/03545

(57) ABSTRACT

This disclosure includes a device and method for interacting with a touch screen surface. The device may include any material that may interact with a surface and be a replacement for human contact with the surface. The device may be sensed by a capacitive touch screen. The device may include a transaction card having a silicone material on a portion of the transaction card. The silicone material may be integrated into at least a portion of the transaction card or the silicone material may be a separate component that interfaces with the transaction card.

### CROSS-REFERENCE TO RELATED APPLICATIONS

This disclosure claims priority to and the benefit of U.S. Provisional Ser. No. 63/044,543 filed Jun. 26, 2020 and entitled “TRANSACTION CARD MICRO STYLUS,” which is incorporated herein in its entirety for all purposes.

### FIELD

This disclosure generally relates to a stylus, and more particularly, to a stylus incorporated onto a transaction card.

### BACKGROUND

People often want to maintain a clean and sterile environment to stay healthy. People also want to avoid catching germs and viruses from others. When a person touches a surface, the germs or viruses may stay on that surface for a period of time. Thus, the germs or viruses may unintentionally infect the next person that touches that same surface. While many people will try to clean surfaces before touching the surfaces, people do not often have the proper sanitation wipes or the proper chemicals to appropriately sanitize a surface. Moreover, people do not want to spend the time to clean surfaces, or an insufficient amount of time exists for cleaning since other people may be waiting to use the same device. While some “germophobes” may try to avoid certain surfaces, people may need to interact with certain devices in order to perform daily routines or conduct commerce. Furthermore, with the recent global pandemic, more people are hyper-aware and hyper-concerned about cleanliness and avoiding interaction with surfaces commonly used by others. As such, a strong need exists to have a convenient device that allows a person to avoid touching a device, but still have the ability to interact with the device.

In order for the world to be prepared for the future with minimal exposure to contaminants and minimal contact, transactions are going to need to be as hands-free as possible. In that regard, chip readers may become antiquated because with Tap-To-Pay consumers can easily avoid making contact with unnecessary objects. Moreover, due to environmental concerns, the printed receipt will be eliminated or reduced for everything, except for cash transactions. However, a signature for authorization may still be necessary, but the signature will be increasingly captured via touch screens.

### SUMMARY

This disclosure includes a device and method for interacting with a touch screen surface. The device may include any material that may interact with a surface and be a replacement for human contact with the surface. The device may be sensed by a capacitive touch screen. For example, the device allows a user to safely touch buttons and sign on a POS terminal screen. The device may include a transaction card having a material on a portion of the transaction card, wherein the material can be sensed by a capacitive touch screen. The material may include any type of stylus. The stylus portion may be a silicone material that may be integrated into at least a portion of the transaction card or the silicone material may be a separate component that interfaces with the transaction card.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 is an exemplary drawing of a side view of the stylus, in accordance with various embodiments.

FIG. 2 is an exemplary drawing of a rear view of the stylus, in accordance with various embodiments.

FIG. 3 is an exemplary drawing of a point view of the stylus, in accordance with various embodiments.

FIG. 4 is an exemplary drawing of a front view of the stylus, in accordance with various embodiments.

FIG. 5 is an exemplary drawing of a top view of the stylus, in accordance with various embodiments.

FIG. 6 is an exemplary drawing of a bottom view of the stylus, in accordance with various embodiments.

FIG. 7 is an exemplary drawing of a card slot outline of the stylus, in accordance with various embodiments.

FIGS. 8A-8L are exemplary drawings of various views of another design of the stylus, in accordance with various embodiments.

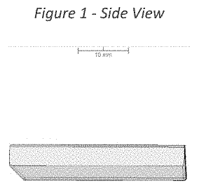

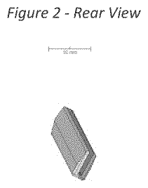

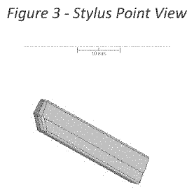

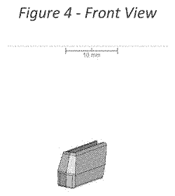

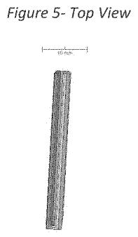

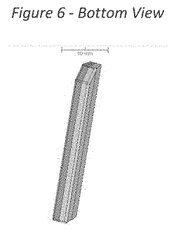

### DETAILED DESCRIPTION

This disclosure includes a device and method for interacting with a touch screen surface. In various embodiments, the device may include any material that may interact with a surface. The device may be a replacement for human contact with the surface and/or may be a replacement for using a public stylus. The device may be sensed by a capacitive touch screen. For example, the device may allow a user to operate or interact with a point of sale (POS) terminal screen. The interaction may include safely touching buttons and/or signing a signature on the screen. In various embodiments, the device may include a transaction card having a material on a portion of the transaction card, wherein the material can be sensed by a capacitive touch screen. The material may include any type of stylus. In various embodiments, the stylus portion may be a silicone material.

The transaction card, as used herein, may include a credit card, debit card, identification card, etc. The transaction card may also include any other device such as a smartphone, wallet, cellular phone, business card holder, make-up compact, tissue holder, cigarette holder and/or the like.

In various embodiments, the stylus may be integrated into at least a portion of any part of the transaction card. The silicone material may be adhered to at least a portion of a first side of the transaction card, at least a portion of a second side of the transaction card, at least a portion of a corner of the transaction card, around the entire outer circumference of the transaction card and/or along at least an edge of the transaction card. The silicone material may be integrated into any portion of any surface of the transaction card.

In various embodiments, the silicone material may be a separate component that interfaces with the transaction card. For example, the device includes a stylus that is adhered to the corner of the user's transaction card. The stylus portion of the device may be about 3.5 mm wide, 35 mm in length, and 7 mm in height. In various embodiments, the stylus may be, for example, 3.5 mm wide, by 4 mm in length, 4 mm tall.

In various embodiments, the stylus portion of the device may be interfaced with any portion of the transaction card (e.g., the bottom right corner of the transaction card). The stylus may include a channel for receiving a portion of the transaction card. The stylus is adhered to the transaction card by applying an adhesive on the stylus and/or the transaction card. The adhesive may comprise a double-sided adhesive that is custom manufactured by 3M called “Ref 9425 HT.” In various embodiments, the device may be constructed by sliding the adhesive lined corner of the transaction card into the channel (e.g., card slot) of the stylus from the top until the outer edges of the transaction card substantially align with card slot. When transaction card is fitted into the card slot, the sides of the stylus are pinched to promote a solid bond between the stylus, the adhesive and the transaction card.

Installing the stylus on the bottom right corner of a credit card does not impede magnetic strip such that the magnetic strip can still be used for payment and other transactions. The stylus length of 35 mm is compatible with chip readers such that the stylus does not interfere with the transaction card or the reader, when the transaction card is inserted into a chip reader. The device fits in a standard wallet card slot both vertical and horizontal. The stylus portion of the device is easily removed from and/or replaced on the transaction card.

The adhesive may not be permanent. The stylus may be removed at the user's discretion by pulling with sufficient force for removal. The stylus is adhered with enough friction that it is not likely to fall off of the transaction card by mistake given every-day conditions.

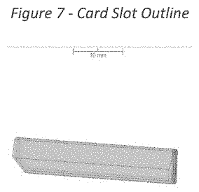

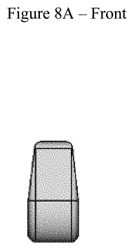

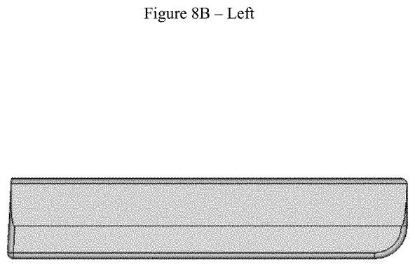

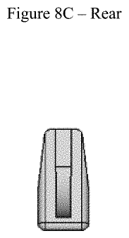

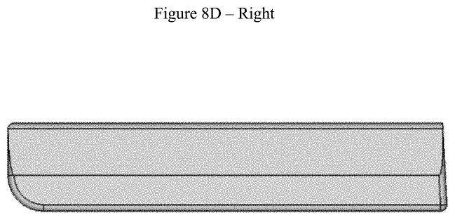

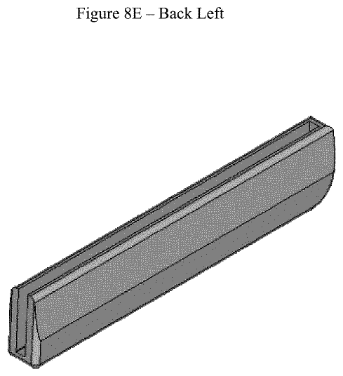

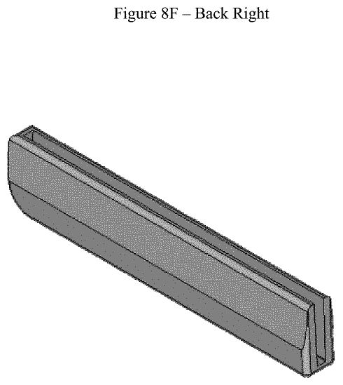

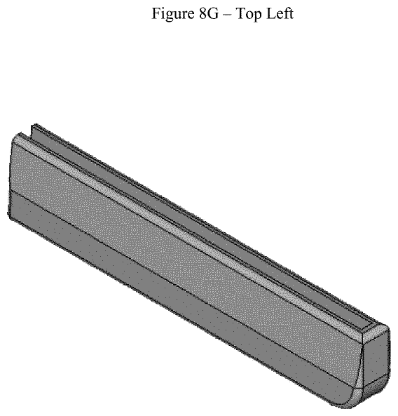

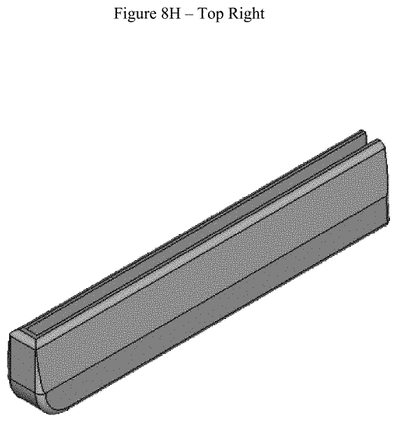

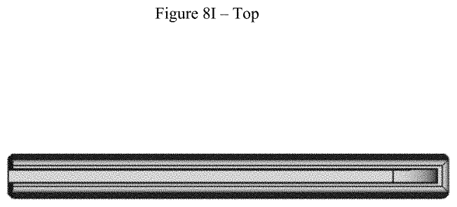

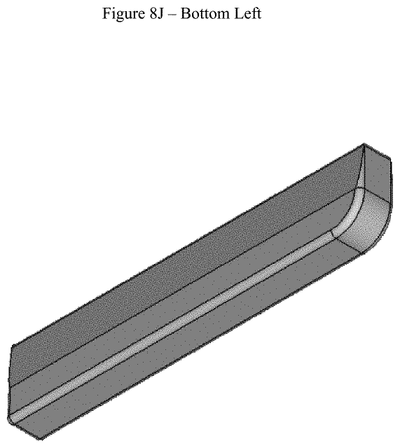

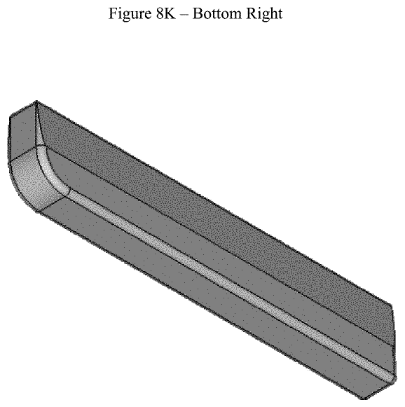

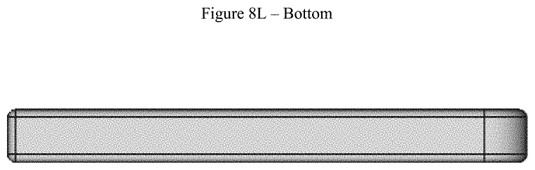

In various embodiments, the stylus may be comprised of a conductive silicone called Elastosil LR3003/70. The stylus material may be non-toxic. The stylus may be solid without any pockets or cavities, aside from the channel that receives the transaction card. However, other pockets or cavities in the stylus may be contemplated. The stylus material feels soft like household silicone which allows a “squish effect” ensuring users make enough surface area contact with the screen to prompt a response. In use, the user may pinch the sides of the stylus at the back end (e.g., the right side of the stylus in FIG. 7) allowing the user to operate capacitive touch screens. When the user's fingers contact the conductive silicone, the stylus picks up the capacitance of the human body, therefore capacitive touch screens register a human touch and respond to typing as well as signing a signature. The user is not limited to only using the stylus tip. The user may use any part of the stylus they desire so long as they make enough surface contact with the screen. In various embodiments, the stylus also similarly works with non-capacitive touch screens via mechanical pressure. The stylus may be used on its own without the transaction card.

Stylus pens are not designed for pressure touch screens as their stylus tips are inflated with air and not solid. Stylus pens also have a designated stylus point that must be used to interact with the screen. In contrast, the present device can be used with any part of the stylus to operate a touch screen. For example, the sides, front, or bottom could be used, but the corner is preferred.

The stylus may also include any indicia such as, for example, logos, names, advertising, etc. The stylus may be provided in different colors. The stylus is also considered a micro stylus, so it is much smaller than any other stylus on the market.

The detailed description of exemplary embodiments herein makes reference to the accompanying drawings, which show exemplary embodiments by way of illustration and its best mode, and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Systems and methods are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A device comprising a transaction card having a stylus on a portion of the transaction card, wherein the stylus is configured to interact with a touch screen surface.

2. The device of claim 1, wherein the stylus is configured to interact with the touch screen surface by the stylus being sensed by a capacitive touch screen.

3. The device of claim 1, wherein the stylus is integrated into at least a portion of the transaction card.

4. The device of claim 1, wherein the stylus is a separate component that interfaces with the transaction card.

5. The device of claim 1, wherein the stylus adheres to the transaction card with an adhesive.

6. The device of claim 1, wherein the stylus comprises a silicone material.

7. The device of claim 1, wherein the transaction card is at least one of a credit card, debit card, identification card, smartphone, wallet, cellular phone, business card holder, make-up compact, tissue holder, or cigarette holder.

8. The device of claim 1, wherein the stylus includes a channel that receives the transaction card.
